(19) United States
(12) Patent Application Publication
(10) Pub. No.: US 2004/0203540 A1
(43) Pub. Date: Oct. 14, 2004

(54) Combined RF peak suppression and pre-distortion circuit

(76) Inventors: Kiomars Anvari, Alamo, CA (US); Michael Alan Parker, Antioch, CA (US)

Correspondence Address: Kiomars Anvari, 1567 SERAFIX RD, ALAMO, CA, 94507, US

(21) Appl. No.: 10/412,537

(22) Filed: Apr. 14, 2003

(51) Int. Cl. H04B 1/04; H01Q 11/12

(52) U.S. Cl. 455/114.3; 455/114.2; 455/116

(57) ABSTRACT

A technique for peak suppressing and pre-distorting the input signal to wireless amplifiers to improve the linearity of the amplifier and subsequently significantly improving the power efficiency of the amplifier is described. The input to the amplifier, prior to being applied to the amplifier, is modified by a peak suppression and pre-distortion circuit. The peak suppression and pre-distortion circuit uses samples of the output of the amplifier to adaptively adjust a lookup table that is being used for pre-distortion. The input and output of the peak suppression and pre-distortion circuit are at the amplifier frequency. The peak suppression and pre-distortion is performed in digital domain at baseband.

### BACKGROUND OF INVENTION

The present invention relates to a RF pre-distortion and peak suppression module to linearize an RF power amplifier. The peak suppression and pre-distortion module input is the RF input to the amplifier (if the pre-distortion is not used) and its output is the pre-distorted RF signal as a new input to the amplifier. In any wireless communication system one of the critical components is the power amplifier. This component has a major contribution in cost, power consumption, and size of the system. The reason is the requirement of most of the wireless communication system for linear power amplifiers. The higher the linearity, the higher the power consumption, cost and size. In order to minimize the cost, size and power consumption there is a need for techniques that overcome this problem. This invention conquers these challenges by using a simple and accurate peak suppression and pre-distortion module used at the input to the power amplifier.

### SUMMARY OF INVENTION

According to the invention, a low-cost RF pre-distortion peak suppression module, for use with RF power amplifier, uses a plurality of simple and accurate circuits in conjunction with intelligent signal processing to improve the linearity of the power amplifier. By intelligent, it is meant that the peak suppression and pre-distortion module has features of adaptability to the environment, such as ability to select a particular frequency or channel, and consider the changes due to environmental changed and aging. The peak suppression and pre-distortion module uses the amplifier input as its input and condition the input before applying to the amplifier. The conditioning or peak suppression and pre-distortion helps the amplifier acts more linearly. The conditioning is based on pre-defined parameters stored in a lookup table and equalization techniques. The equalization techniques are designed to adaptively optimize critical performance criteria such as adjacent channel power ratio (ACPR) and error vector magnitude (EVM) characteristics of the amplifier signal output. The lookup table parameters are the result of the comparison of the output of the amplifier and the input to the peak suppression and pre-distortion box and being updated real time and adaptively. The inputs to the pre-distortion peak suppression should be within a limit that can be handled by the peak suppression and pre-distortion module. The inputs and the output or the peak suppression and pre-distortion module are all RF.

In a particular embodiment, the pre-distortion unit comprises a transmitter and two receivers, a signal processing, and a clock generator. The transmitter and receivers convert the RF signal to baseband and the baseband signal to RF. The signal processor performs the signal conditioning as well as adaptively updating the pre-distortion lookup table. The signal processor also performs the initial calibration, and timing synchronization as well as transmitter and receivers control.

The invention will be better understood by reference to the following detailed description in conjunction with the accompanying drawings.

### BRIEF DESCRIPTION OF THE DRAWINGS

FIG. 1 is an overall block diagram of the a linearized power amplifier using peak suppression and pre-distortion

FIG. 2 is the block diagram of the peak suppression and pre-distortion module

FIG. 3 is the block diagram of the baseband processing unit of peak suppression and pre-distortion module

FIG. 4 is the block diagram of the peak suppression and pre-distortion blocks

FIG. 5 is the block diagram of the look up table adaptation algorithm

FIG. 6 is the block diagram delay adjustment algorithm

FIG. 7 is the block diagram of the gain adjustment algorithm

FIG. 8 is the block diagram of sample selection

FIG. 9 is a block diagram of the equalization filter optimization algorithm

### DESCRIPTION OF THE SPECIFIC EMBODIMENTS

In a first preferred embodiment the peak suppression and pre-distortion module monitors the signal strength of the input signal channels using the input receiver and finds the frequency and channel number of the input signal. In a second preferred embodiment of the invention, the pre-distortion and peak suppression circuit uses sub-harmonic sampling to convert RF or IF signals from its input and the feedback signal from the amplifier to digital baseband signal. In a third preferred embodiment the input signal is conditioned or pre-distorted and peak suppressed using an equalizer and pre-distortion data stored in a lookup table before being transmitted to the amplifier. In a fourth embodiment the input signal and the feedback signal from the amplifier are used to adaptively update the conditioning or pre-distortion lookup table. In a fifth embodiment the feedback signal from the amplifier are used to adaptively update the equalization filter operating upon the main input signal in order to enhance the ACPR and EVM characteristics of the amplifier output.

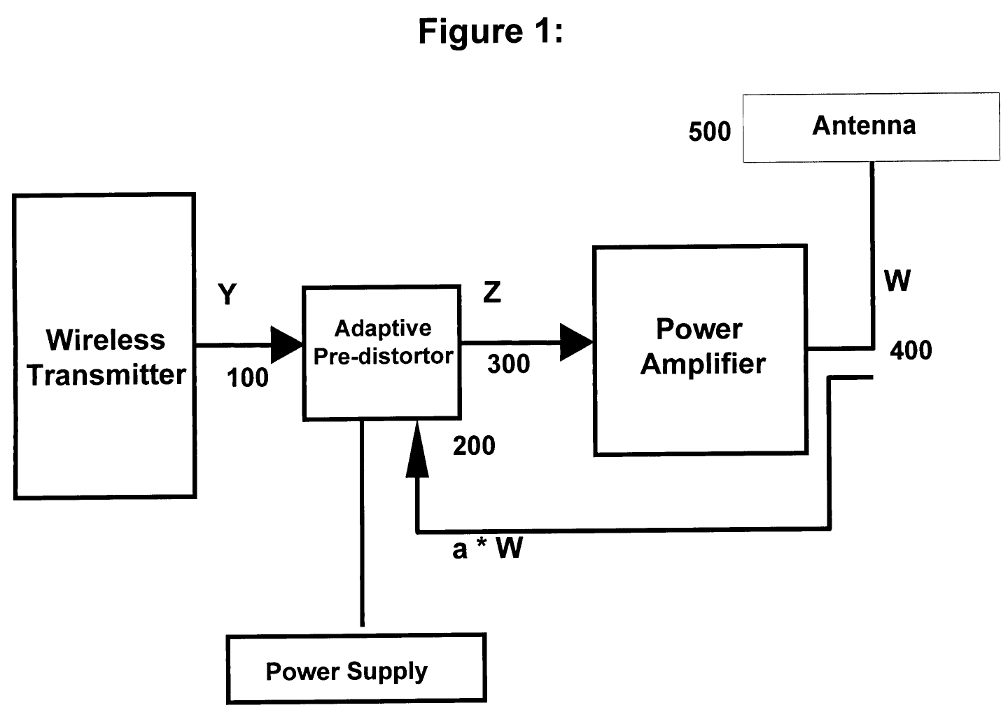

Referring to FIG. 1, a peak suppression and pre-distortion circuit diagram is illustrated. The systems receive its inputs from wireless transmitter 100 and feedback from output of the amplifier 200. A sample of the amplifier output 400 is fed back to the peak suppression and pre-distortion circuit. The output of the pre-distortion peak suppression circuit 300 is applied to the input of the power amplifier. The pre-distortion peak suppression circuit performs the following functions:

1. Find the frequency and channel number of the wireless transmitter output 100. The operating frequency can also be input to the pre-distortion unit.

2. Perform calibration process in order to estimate the timing and initial lookup table values.

3. Perform ACPR measurement and EVM upon feedback signal. Select one of multiple equalization filter coefficient sets based upon iterative measurements until optimum result achieved

4. Peak suppress and equalize the input signal 100 before applying pre-distortion.

5. Pre-distort the suppressed and equalized input signal 100 before sending it to the amplifier input 300

6. Use the input signal from the wireless transmitter 100 and the input signal 200 from the output of the amplifier to adaptively up date the lookup table.

7. Adaptively adjust the gain in the signal paths from main and feedback receivers in DSP2 to an equal and optimal level for further processing.

8. Adaptively adjust the delay of the main receiver signal path in DSP2, until the main and feedback signals are aligned in time/phase. This is measured by cross-correlating between the two signals.

9. Select the best sample value by changing the decimation filter coefficients. This allows the delay to be adjusted to a small fraction of input signal symbol period.

10. Periodically measure ACPR and EVM in order to continually optimize equalization filter as necessary to maintain optimum performance.

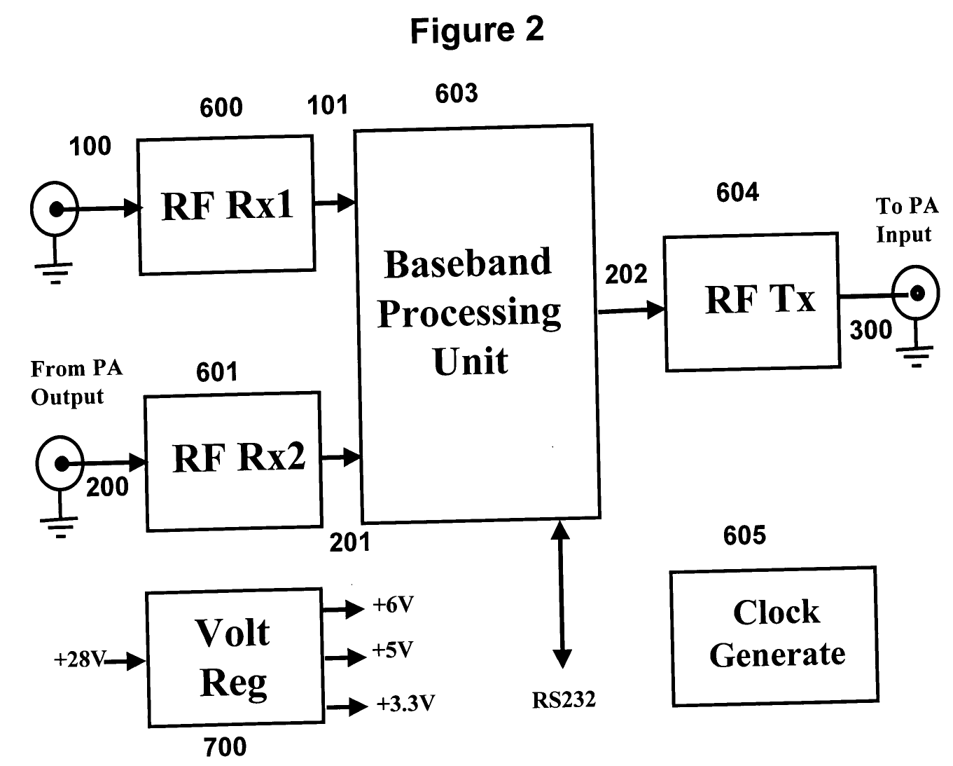

FIG. 2 illustrates the detail block diagram of the peak suppression and pre-distortion circuit unit. The RF received signal from wireless transmitter 100 and the feedback signal 200 from output of the amplifier are applied to receiver 600 and 601. The output of the receiver 600 and 601 are applied to signal processing block 603 for digital signal processing which are peak suppression and pre-distortion, and adaptation and updating of the pre-distortion lookup table. The output of signal processing block 603 the peak suppressed and pre-distorted signal 202 is applied to transmitter 604 to create the input signal 300 for the power amplifier. Clock generator 605 produces all the clocks necessary for the pre-distortion circuit and the power supply block 700 produce all the voltages necessary for the pre-distortion circuit.

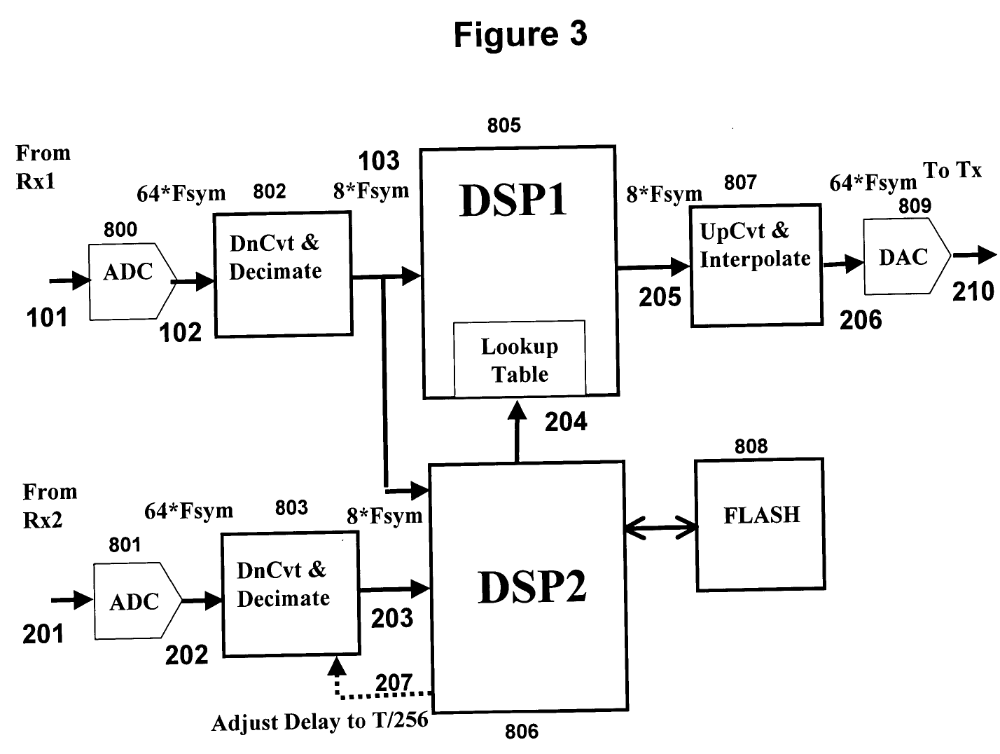

FIG. 3 shows the detail block diagram of the peak suppression and pre-distortion signal processing block 603. The receiver block 600 output 101 is applied to analog to digital converter block 800 to produce the digital signal 102. The receiver block 601 output 201 is applied to analog to digital converter block 801 to produce the digital signal 202. In both cases the analog to digital conversion is based on sub-harmonic sampling. The output of the analog to digital converter 800 is applied to the down converter block 802 to produce down converted and decimated signal 103 which is eight times the symbol rate of the input signal 100 applied to receiver 600. The output of the analog to digital converter 801 is applied to the down converter block 803 to produce down converted and decimated signal 202 which is eight times the symbol rate of the input signal 200 applied to receiver 601.

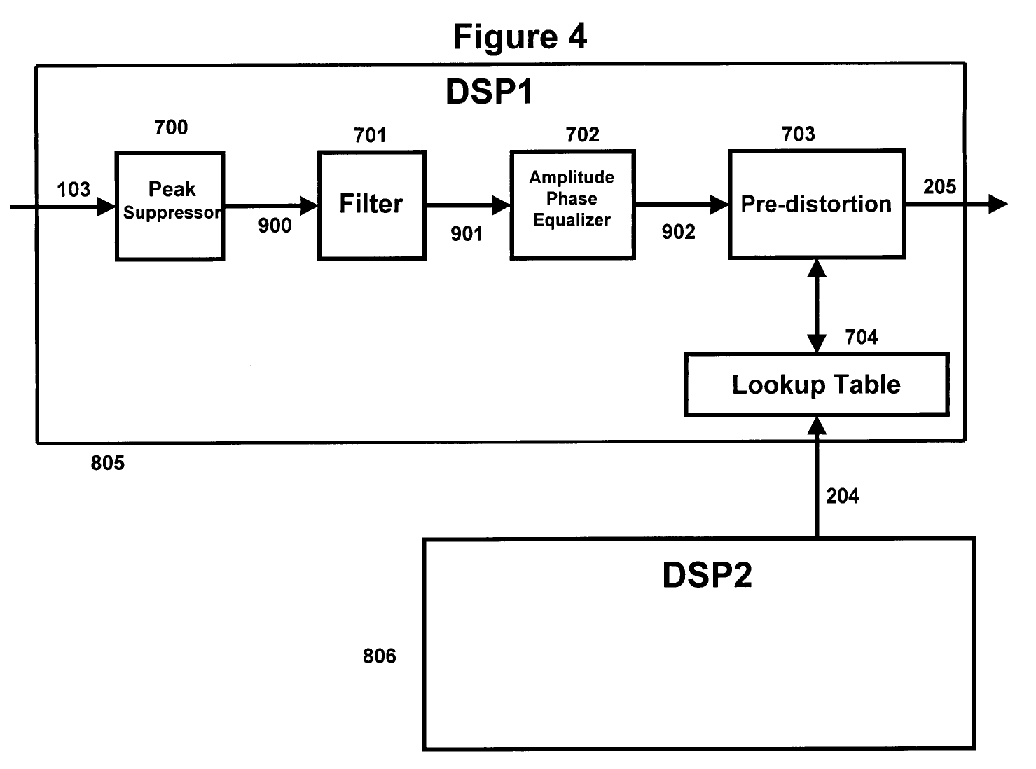

FIG. 4 shows the detail block diagram of the peak suppression and pre-distortion signal block 805. The signal 103 from the main receiver is peak suppressed by block 700 to produce the peak suppressed signal 900. The peak suppressed signal 900 then is filtered by filter block 701 to produce a peak suppressed and filtered signal 901. The peak suppressed and filtered signal 901 is then phase and amplitude equalized by the phase and amplitude equalizer 702 to produce signal 902. The signal 902 is then applied into the pre-distortion block 703 to produce the peak suppressed and pre-distorted signal 205 using the data from lookup table 704. The data in lookup table 704 are adaptively updated by DSP2 block 806.

The down converted and decimated signal 103 is applied to digital signal processing block 604 to produce a peak suppressed and pre-distorted signal 205 using the data stored in the lookup table. This signal 205 is then interpolated and up converted by block 807 and the signal 206 is produced. The signal 206 is applied to digital to analog converter 809 and signal 210 is produced at the output.

The down converted and decimated signal 203 and 103 are both applied to digital signal processing block 806. The digital signal processing block 806 uses these signals to update the pre-distortion lookup table. The block 808 stores the code for all the digital signal processing functions.

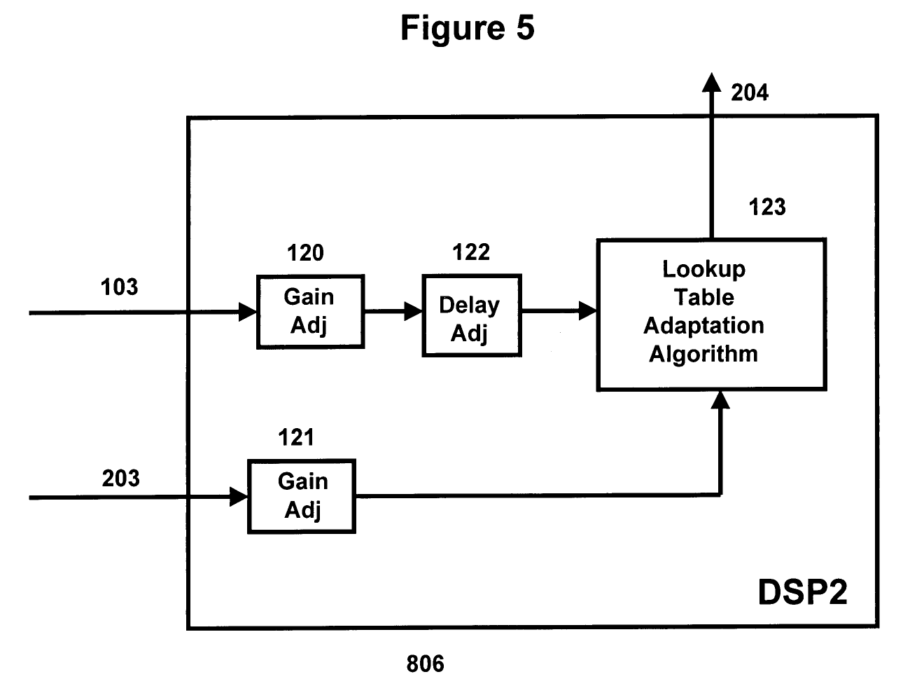

FIG. 5 shows the detail block diagram of the lookup table adaptation algorithm. The signal 103 from the main signal receiver is gain adjusted by 120 and delay adjusted by 122 and then applied to look up table adaptation algorithm 123. The feedback signal 203 from the feedback signal receiver is gain adjusted 121 before being applied to lookup table adaptation algorithm 123. The adaptation algorithm 123 uses the two signal to produce the update values for the lookup table 704. The adaptation algorithm can use one of the readily available algorithms.

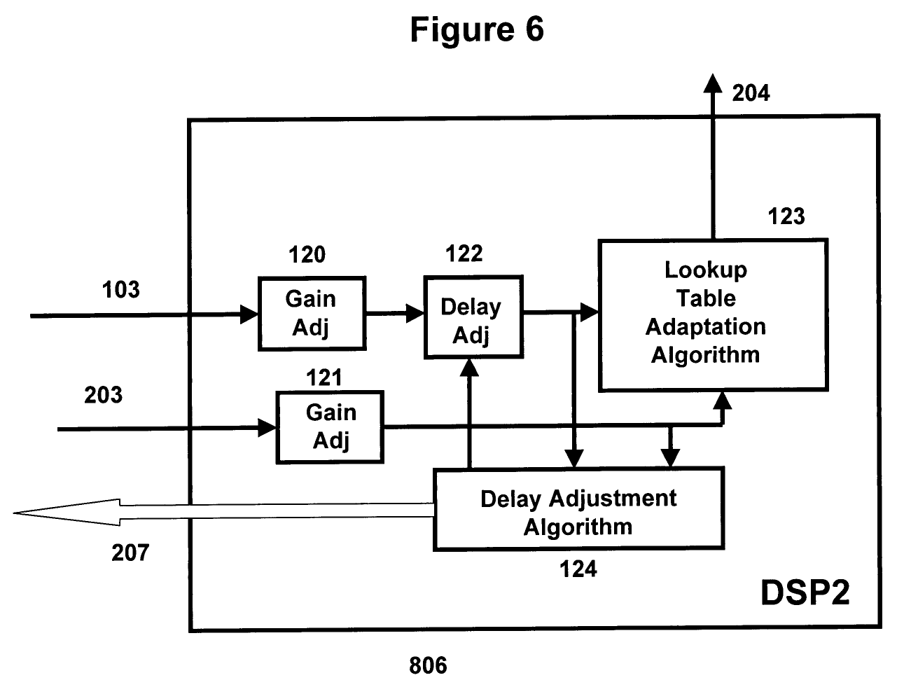

FIG. 6 shows the detail block diagram of the delay adjustment algorithm. The algorithm operates in two modes. During the initial mode the initial delay between main signal from the main receiver 600 and the feedback signal from the feedback receiver 601 is calculated. During this mode the signal 103 is replaced with a known sequence with very high auto-correlation. The signal input 203 to DSP2 will be decimated to eight times the symbol rate, with a sampling phase resolution at minimum of 1/256 times the symbol period by block 803. The sampling phase is repeatedly adjusted in increments of 1/256 of the symbol period and correlated with known sequence 103 in block 124 to determine the delay present to a high degree of precision required by the lookup table adaptation algorithm in block 123. In operation, this delay will be compensated for by digitally delaying the signal from input 103 of DSP2 by an integer number of samples in block 122, and adjusting the sampling phase of the decimator in block 803 based upon the delay measurement results obtained in block 124 using the delay adjustment algorithm which is based on correlation of the output of blocks 122 and 121. In operation lookup table adaptation algorithm 123 then operates upon the output signal 100 from the wireless transmitter and the feedback signal 200 from the amplifier output, which are precisely aligned in time and phase relative to each other. This adjustment is adaptively maintained during operation, to compensate for any delay variations caused by amplifier properties changing with aging effect and temperature variation.

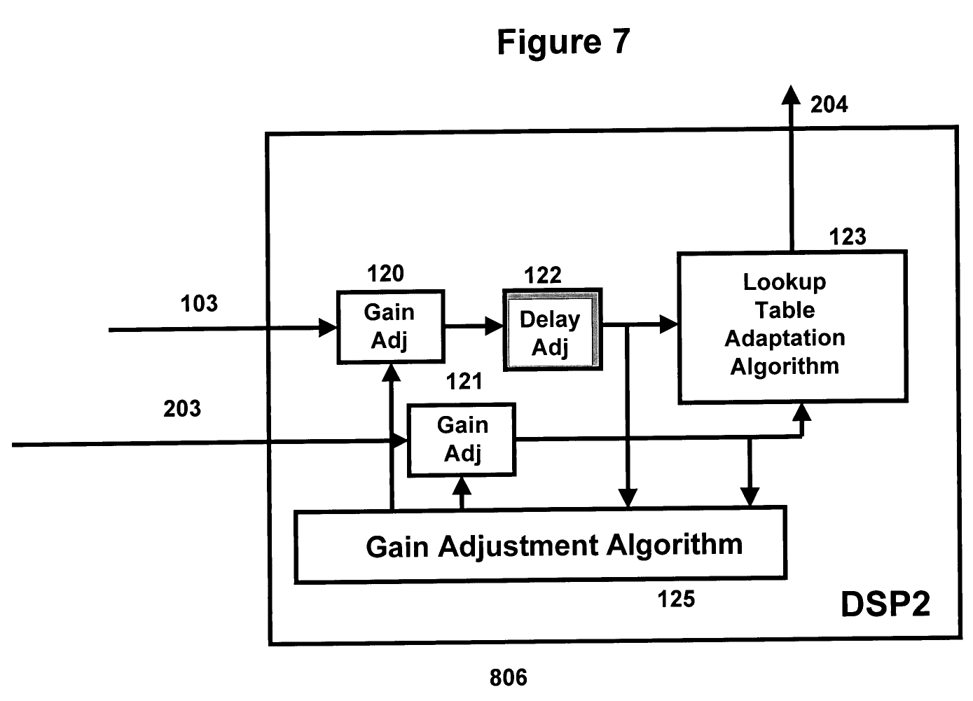

FIG. 7 shows the gain adjustment procedure in the path of the two inputs 103 and 203 to the lookup table adaptation algorithm block 123. Block 125 the gain adjustment algorithm gets its input from the output of the blocks 121 and 122. The automatic gain control operation with common set-point which is performed by block 125 adjust the gain in blocks 120 and 121, which allow the lookup table adaptation algorithm to operate in signals of known and common amplitude level. The dynamic range requirements of the algorithm are therefore reduced. This automatic gain control operation is not performed upon the main input signal to DSP 1.

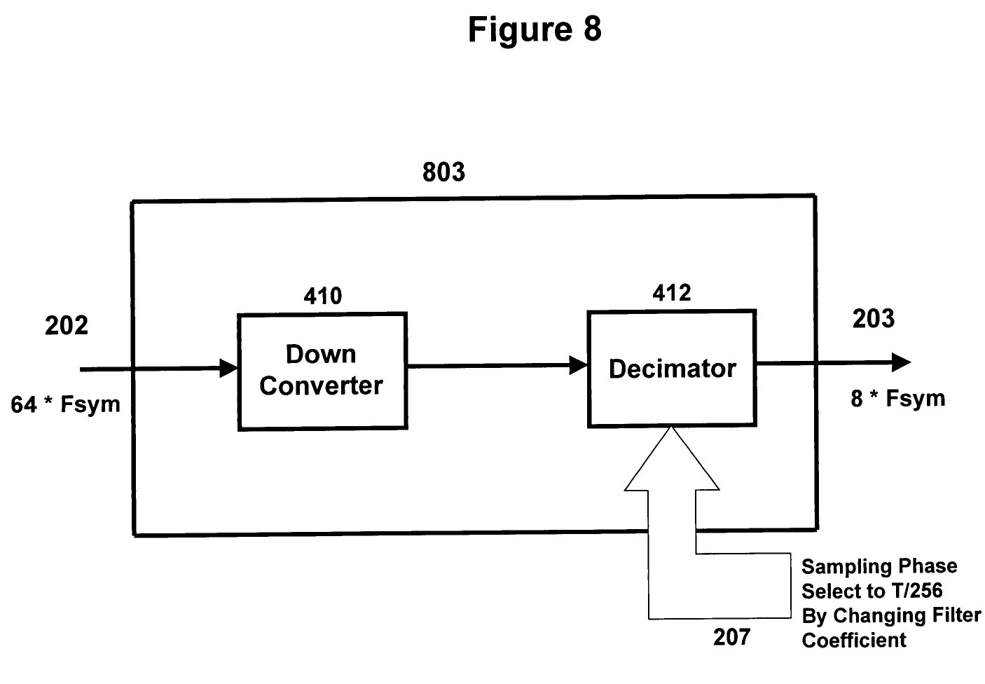

FIG. 8 shows the down converter decimator block diagram of 803, which is used for delay adjustment of the two inputs into the lookup table adaptive algorithm. The decimator filter coefficients are changed based on the delay adjustment algorithm block 124 output 107 to produce phase change steps of T/256.

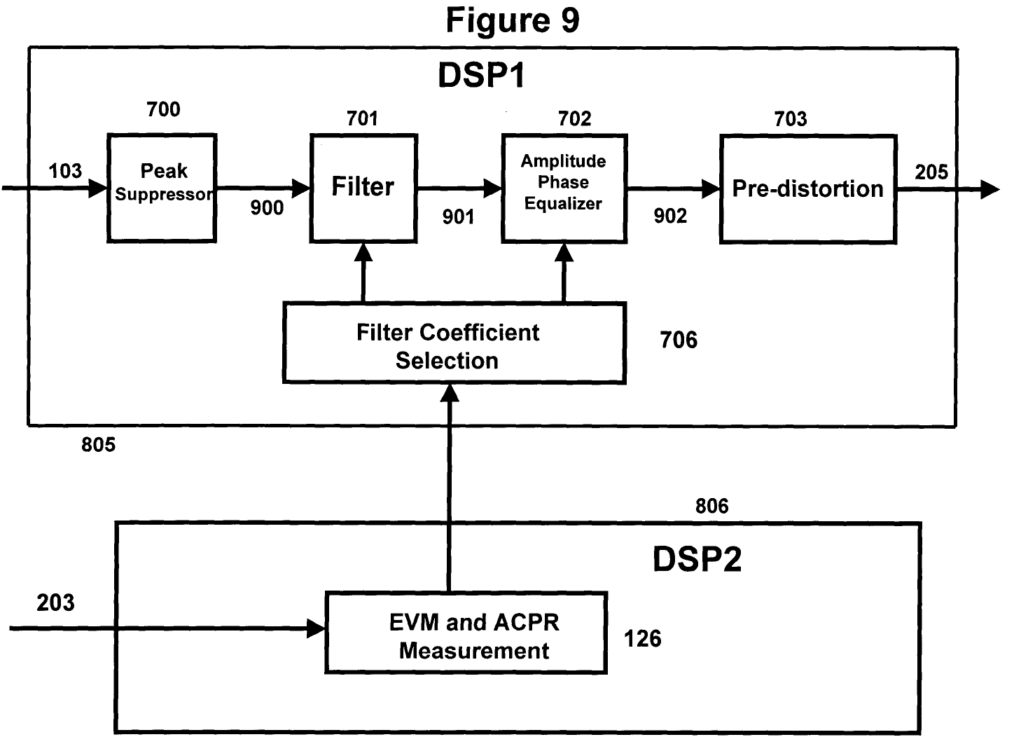

FIG. 9 shows the equalization filter optimization block diagram, which is used to enhance the adjacent channel power rejection and signal constellation error vector magnitude. Input 203 of DSP2 is measured by block 126 to determine ACPR and EVM characteristics of the amplifier output for each available filter coefficient from block 706 set used in filter block 701 and 702 in DSP1. This allows different filters to be used dependent upon the output power of the amplifier, number of code channels active, and frequency or other characteristics of the main input signal. The filter coefficient set is dynamic, and can be modified during amplifier operation as ACPR and EVM measurements warrant.

What is claimed is:

1. A wireless peak suppression and pre-distortion circuit for use with power amplifiers in a wireless communication system to enhance the linearity and performance of the amplifier, in particular wireless cellular, PCS, wireless LAN, and satellite communication systems, the peak suppression and pre-distortion circuit comprising:
Two receivers one for the peak suppression and pre-distortion main signal input and one for amplifier feedback input.
A digital signal processing block to peak suppress and pre-distort the main input signal using a lookup table.
A digital signal processing block to use the main input signal and amplifier feedback input to adaptively update the pre-distortion lookup table.
A digital signal processing block to evaluate the delay between the main signal and the amplifier feedback signal and adjust the main signal delay before being used by the lookup table adaptation algorithm. The algorithm will continuously adjust the delay during the operation.
A digital signal processing block to evaluate the gain between the main signal and the amplifier feedback signal and adjust the both signal's gain before being used by the lookup table adaptation algorithm. The algorithm will continuously adjust the gain during the operation.
A digital signal processing block to accurately evaluate the delay between the main signal and the amplifier feedback signal by changing the coefficient of a decimation filter used in the path of amplifier feedback signal to produce T/256 accuracy.
A transmitter block that prepare the peak suppressed and pre-distorted main signal for delivery to power amplifier.

2. The peak suppression and pre-distortion circuit according to claim 1, wherein main input signal from the wireless transmitter is sampled using sub-harmonic sampling technique at the input frequency or at an intermediate frequency.

3. The peak suppression and pre-distortion circuit according to claim 1, wherein main input signal from the wireless transmitter is sampled using sub-harmonic sampling technique at the input frequency or at an intermediate frequency and the digitized main input signal is down converted digitally and decimated to the appropriate number of samples per symbol for further digital signal processing.

4. The peak suppression and pre-distortion circuit according to claim 1, wherein feedback input signal from the wireless power amplifier is sampled using sub-harmonic sampling technique at the input frequency or at an intermediate frequency.

5. The peak suppression and pre-distortion circuit according to claim 1, wherein feedback input signal from the wireless power amplifier is sampled using sub-harmonic sampling technique at the input frequency or at an intermediate frequency and the digitized feedback input signal is down converted digitally and decimated to the appropriate number of samples per symbol for further digital signal processing.

6. The peak suppression and pre-distortion circuit according to claim 1, wherein the digital main signal is peak suppressed, filtered using linear phase filter, equalized both phase and amplitude using constant gain phase equalization filter and constant group phase amplitude equalization filter, and pre-distorted before being prepared for up conversion.

7. The peak suppression and pre-distortion circuit according to claim 1, wherein the peak suppressed, filtered, equalized (both amplitude and phase), and pre-distorted main signal using a lookup table is digitally up converted and converted to analog domain at an intermediate frequency or the output frequency.

8. The peak suppression and pre-distortion circuit according to claim 1, wherein the digitized main signal and feedback signal are used to adaptively update the pre-distortion lookup table, wherein the main signal samples are delayed to match the samples from the amplifier feedback input before being used by lookup table adaptation algorithm, wherein the man signal samples and the amplifier feedback signal samples are gain controlled before being used by the lookup table adaptation algorithm.

9. The peak suppression and pre-distortion circuit according to claim 1, wherein feedback input signal from the wireless power amplifier is sampled using sub-harmonic sampling technique at the input frequency or at an intermediate frequency and the digitized feedback input signal is down converted digitally, decimated down to the appropriate number of samples per symbol with a sampling phase to allow phase alignment (in T/256 steps) with the main input signal for further digital signal processing by the adaptation algorithm.

10. The peak suppression and pre-distortion circuit according to claim 1, wherein main input signal and digitized feedback input signal are aligned in amplitude by automatic gain control operations prior to further processing by the lookup table adaptive algorithm which updates the pre-distortion lookup table.

11. The peak suppression and pre-distortion circuit according to claim 1, wherein the delay described in claim 1 is measured by initially generating a digital signal with high autocorrelation property, such as a pseudo random sequence used by the main signal path, and correlation of this sequence with the amplifier output feedback signal by delay adjustment algorithm. The correlation window is incremented by adjusting the sampling phase in decimation block in the path of the amplifier output feedback signal in T/256 steps by changing the coefficients of the decimation filter in the amplifier output feedback signal path, and by incrementing the delay of main input signal used by the delay adjustment algorithm by integer sample unit delays.

12. The peak suppression and pre-distortion circuit according to claim 1, wherein main input signal is adaptively equalized based upon ACPR and EVM measurements performed on the feedback signal from the amplifier output.

13. The peak suppression and pre-distortion circuit according to claim 1 and subsequent claims, when it is used in wireless cellular, wireless PCS, wireless satellite, and any wireless communication systems used for military applications.

14. The peak suppression and pre-distortion circuit according to claim 1, wherein the DSP1 and DSP2 can be implemented in programmable logic, FPGA, Gate Array, ASIC, and DSP processor.
